(19) United States
(12) Patent Application Publication
(10) Pub. No.: US 2025/0329002 A1
(43) Pub. Date: Oct. 23, 2025

(54) METHOD AND SYSTEM FOR SPATIAL FREQUENCY SPECTRUM OPTIMISATION OF WRITTEN TEXT TO CLOSELY RESEMBLE A NATURAL ENVIRONMENT

(71) Applicant: TECHNOLOGICAL UNIVERSITY DUBLIN, Dublin (IE)

(72) Inventors: Daniel Ian FLITCROFT, Dublin (IE); James LOUGHMAN, Dublin (IE)

(21) Appl. No.: 18/288,625

(22) PCT Filed: May 2, 2022
(86) PCT No.: PCT/EP2022/061689

§ 371 Date: Oct. 27, 2023

(30) Foreign Application Priority Data
Apr. 30, 2021 (GB) 2106287.2

(51) Int. Cl. G06T 5/94; G06T 5/20; G06T 11/20

(52) U.S. Cl. CPC G06T 5/94; G06T 5/20; G06T 11/203; G06T 2207/20056; G06T 2207/30176

(57) ABSTRACT

The invention provides a computer implemented method and system modify the appearance of a readable text, said method comprising the steps of obtaining a data text to be adjusted wherein the data text is representative of a readable text; selecting a filtering model and filtering parameters dependent on an analysis of said data text; applying a spatial transformation to the data text according to the selected filtering model and filtering parameters to generate a modified data text having a different spatial contrast characteristic; and outputting the modified data text as a readable text. The invention provides a method to alter the spatial frequency information in text to create a spatial frequency profile that closely resembles a natural outdoor environment, while at the same time preserving the spatial detail required to retain the informational content of the text.

### CLAIM OF PRIORITY

This application is the U.S. National Stage of International Patent Application No. PCT/EP2022/061689 filed 2 May 2022, which claims priority to European Patent Application No. EP 2106287.2 filed 30 Apr. 2021, the entire content of these applications being incorporated herein by reference as if fully set forth below in its entirety and for all applicable purposes.

### FIELD

The disclosure relates to visual optimisation of text and image processing. In addition, the disclosure relates to a method and system to reduce the development of myopia in humans.

### BACKGROUND

In developed countries, reading and education are well-recognised risk factors for myopia development [1-3]. It is known that myopia is rare in indigenous populations with low levels of literacy [4].

Recently a causal relationship has been demonstrated between years in education with increasing myopia using the technique of Mendelian Randomisation [5]. This link between book work and myopia is complex and poorly understood. Spatial frequency content of the retinal image is known to be a highly relevant factor in experimental myopia [6-7], and recently been proposed to be a factor in human myopia [8-9].

Blurring images with Bangerter filters in animal studies has been shown to promote the development of myopia [6-7]. Conversely, it has been claimed that blurring peripheral vision in humans with optical filters reduces myopia progression, for example a disclosed in European Patent Publication EP 2 379 028 B1, assigned to Wisconsin Med College Inc.

Another factor that has been recognised as reducing the development of myopia is time outdoors. Natural outdoor environments have a very characteristic spatial frequency spectrum where the amplitude of spatial frequency components in an image reduce with increasing frequency such that amplitude=1/f^{α}.[10] In natural images α is close to −1. On a log Amplitude vs log Spatial frequency plot this leads to an almost straight line with a slope of −1 as shown in FIG. 1a.

There is a need to provide new methods and tools to assist in reading text and in particular for the reduction of myopia development. The present disclosure aims to provide a solution to assist in the reduction of myopia development.

### SUMMARY

According to the invention there is provided, as set out in the appended claims, a computer implemented method and system to modify the appearance of a readable text, said method comprising the steps of: obtaining a data text to be adjusted wherein the data text is representative of a readable text; selecting a filtering model and/or filtering parameters dependent on an analysis of said data text; applying a spatial transformation to the data text according to the selected filtering model and filtering parameters to generate a modified data text having a different spatial contrast characteristic; and outputting the modified data text as a readable text.

The invention provides a method and system to alter the spatial frequency information in text to create a spatial frequency profile that closely resembles the natural outdoor environment, while at the same time preserving the spatial detail required to retain the informational content of the text.

In one embodiment the method provides the step of adjusting the spatial frequency spectrum of the data text towards a desired spectrum using a spatial filter.

In one embodiment the spatial filter is a bandpass or a narrow band filter.

In one embodiment the spectral properties of the filter can be calculated from the contrast ratio of text to an ideal spectrum.

In one embodiment there is provided the steps of: using a low-pass filter with a contrast ratio data and creating a model which fits the shape of a contrast ratio curve over a selected range of spatial frequencies for visual reading.

In one embodiment the method comprises the step of analysing the readable text for a particular font and comparing fonts in terms of their frequency spectrum and applying the spatial transformation based on the particular font.

In one embodiment the method comprises the steps of: filtering the text data in the spatial domain using a Fourier transform; and applying a filter mask is created which is then multiplied with a two-dimensional FFT amplitude spectrum.

In one embodiment a zero frequency point is shifted to the centre of a FFT matrix and profiles of the required filter masks are created from either the filtered contrast ratio curve or a model.

In one embodiment the method comprises the step of adjusting the confidence levels of the modified data text so that the amount of adjustment of the spatial transformation is controlled.

In one embodiment the amount of text adjustment is adjustable with a scaling parameter.

In one embodiment the spatial filter is a symmetrical function on a log axis and fitted by a log-gaussian model.

In one embodiment the spatial filter is a logGabor function configured to create a set of orientation and band-pass frequency filters to allow for orientation specific spatial filtering.

In one embodiment the method comprises the step of measuring a viewing distance by a device on which the text is presented and adjusting the parameters of the spatial filter based on the measured viewing distance.

In one embodiment the spatial filtering of the text is calculated to increase the simulation of ON-centre retinal cells and decrease the stimulation of OFF-centre retinal cells.

In one embodiment the spatial frequency profile of a specific text font is analysed, spatial filtering applied and a modified text font is stored for later use.

In one embodiment the spatial frequency profile of the text is modified by the addition of a background texture or pattern.

In one embodiment the modified data text is output to a display screen or a viewing device.

In one embodiment the modified data text is output to a printer device.

In one embodiment the modified data text is generated by altering the spatial frequency information in the readable text to create a spatial frequency profile characteristic that reduces or eliminates ocular growth response that leads to myopia development.

In another embodiment there is provided a filter module, suitable for use in or in conjunction with an electronic device, said filter module is configured to obtain a data text to be adjusted wherein the data text is representative of a readable text; and apply a spatial transformation to the data text to generate a modified data text having a different spatial contrast characteristic wherein the modified data text comprises a spatial frequency profile characteristic that closely resembles a natural outdoor environment.

In a further embodiment there is provided a computer system or device, configured to modify the appearance of a readable text, comprising:
a memory;
a processor electrically coupled to the memory and configured to execute instructions received from the memory; and
wherein the processor is further configured to:
obtain a data text to be adjusted wherein the data text is representative of a readable text;
select a filtering model and/or one or more filtering parameters dependent on an analysis of said data text;
apply a spatial transformation to the data text according to the selected filtering model and/or filtering parameters to generate a modified data text having a different spatial contrast characteristic; and
output the modified data text as a readable text to a display screen or printing device.

There is also provided a computer program comprising program instructions for causing a computer program to carry out the above method which may be embodied on a record medium, carrier signal or read-only memory.

It will be appreciated in the context of the present invention the ‘readable text’ hereinbefore described can relate to electronic text on a screen or printed onto a physical reading medium.

### BRIEF DESCRIPTION OF THE DRAWINGS

The invention will be more clearly understood from the following description of an embodiment thereof, given by way of example only, with reference to the accompanying drawings, in which:—

FIG. 1a illustrates a demonstration of natural image spatial frequency distribution;

FIG. 1b illustrates a flowchart showing operation of the invention;

FIG. 2 illustrates how alphabets and scripts have a spatial frequency spectrum that deviates markedly from natural images, as shown in FIG. 1;

FIG. 3 illustrates an example how most of the information content in text is contained in the phase spectrum;

FIG. 4 illustrates different language scripts or texts according to one embodiment of the invention;

FIG. 5 illustrates the contrast ratio between text and an ideal natural spectrum shows a peak at around 8 cycles per degree;

FIGS. 6, 7 and 8 illustrates an asymmetric filter profile of text data when plotted on a log scale for spatial frequency for English, Chinese and Japanese text;

FIG. 9a illustrates a filter mask used to filter image in the spatial domain;

FIG. 9b illustrates the FFT of the spatial frequency spectrum of the text and recombining with original phase spectrum of the text;

FIG. 10 shows a number of examples of reconstructed, spatially spectrum modified text;

FIG. 11 illustrates portions of the examples of FIG. 10 in more detail;

FIGS. 12a, 12b and 12c illustrate the spatial spectra of such filtered texts in three languages, namely English, Japanese and Chinese;

FIG. 13 illustrates the impact of a scaling factor on the spatial frequency attenuation and shown in a linear and log-linear plot;

FIG. 14 illustrate an English text beta value of 0.55 and change the slope of the frequency spectrum to within the 95% confidence intervals of the natural images;

FIG. 15 is similar to FIG. 14 and illustrates a Japanese text having a beta value of 0.70;

FIG. 16 illustrates how the parameters derived from English text in FIG. 14, and applied to the Japanese text of FIG. 15 to achieve the same result;

FIG. 17 illustrates the text when the filter beta value is set to 0.35;

FIG. 18 illustrates a similar text of FIG. 17 when the filter beta value is zero;

FIG. 19 illustrates ON-centre simulation showing the stimulus text and the activation levels for retinal cells;

FIG. 21 illustrates a spatial spectrum of text as processed by ON-centre retinal cells compared to the ideal natural spectrum; and

FIG. 22 illustrates a spatial spectrum of text as processed by OFF-centre retinal cells compared to the ideal natural spectrum.

### DETAILED DESCRIPTION OF THE DRAWINGS

The invention described herein provides a computer implemented method and system to optimise the spatial frequency properties of various alphabets and scripts in common use to match the spatial frequency spectrum of the natural world. The invention can be applied to books and other written materials developed for adults and children in various languages, alphabets and scripts. As well as physical media these transformations can be applied to digital screens, for example ebooks, tablets, phones, televisions and computers and the like.

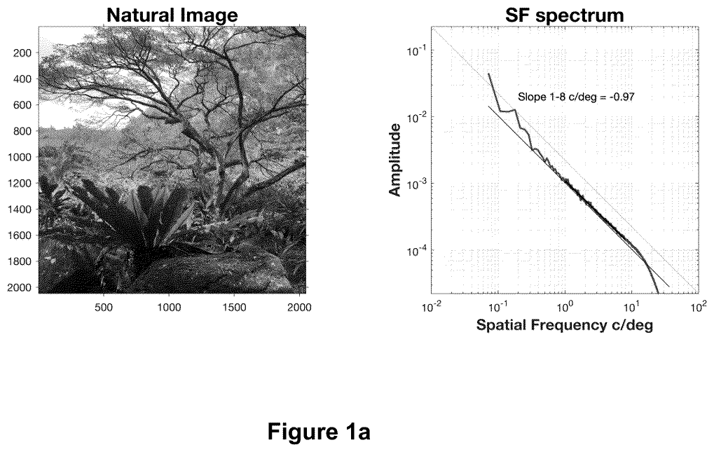

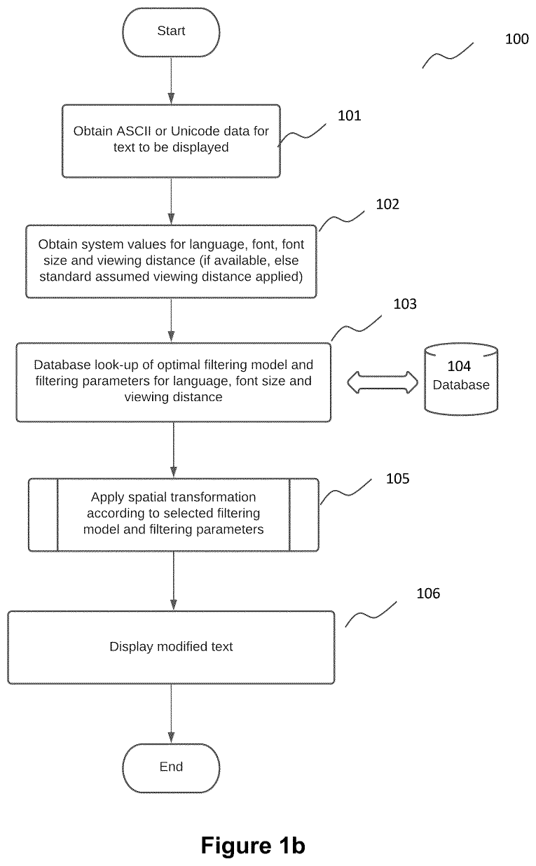

FIG. 1b illustrates a flow chart of the invention in operation, indicated generally by the reference numeral 100. In operation the method comprises the step of obtaining a data text to be adjusted in step 101 wherein the data text is representative of a readable text. The data text is analysed to obtain system values for one or more attributes of the data text in step 102. In step 103 a filtering model is selected and/or one or more filtering parameters dependent on an analysis of the data text is determined. The filtering model can be a pre-stored model stored on a database 104 or created on the fly based on one or more of the parameters of the readable text. A spatial transformation to the data text according to the selected filtering model and filtering parameters is applied to generate a modified data text in step 105. The modified data text will have a different spatial contrast characteristic. The modified data text can be displayed in step 106 as a readable text to a display screen, electronic device or a printer depending on the final application required.

In one embodiment the spatial frequency properties of Western alphabets and Asian alphabets/scripts can be analysed to assess how they differ from each other and from the natural world. Specifically, texts in 12 pt font in English (Roman alphabet), Russian (Cyrillic script), Greek, Hebrew, Arabic, Chinese (simplified and traditional characters), Korean and Japanese were subject to Fourier analysis at the equivalent of a 30 cm viewing distance. Al-based Machine translation was used to generate multiple language versions. The page layout was identical for each language.

A 2048×2048 pixel photopic luminance image was generated and analysed to generate rotationally averaged SF spectra as previously described. The slope of the log amplitude vs log SF relationship (SF slope) was then calculated for each text sample at low (0.5-2 c/deg), intermediate (2-8 c/deg) and high (8-32 c/deg) spatial frequencies. Comparison natural images were obtained from the Natural Scene Statistics in Vision Science from the University of Texas (UT).

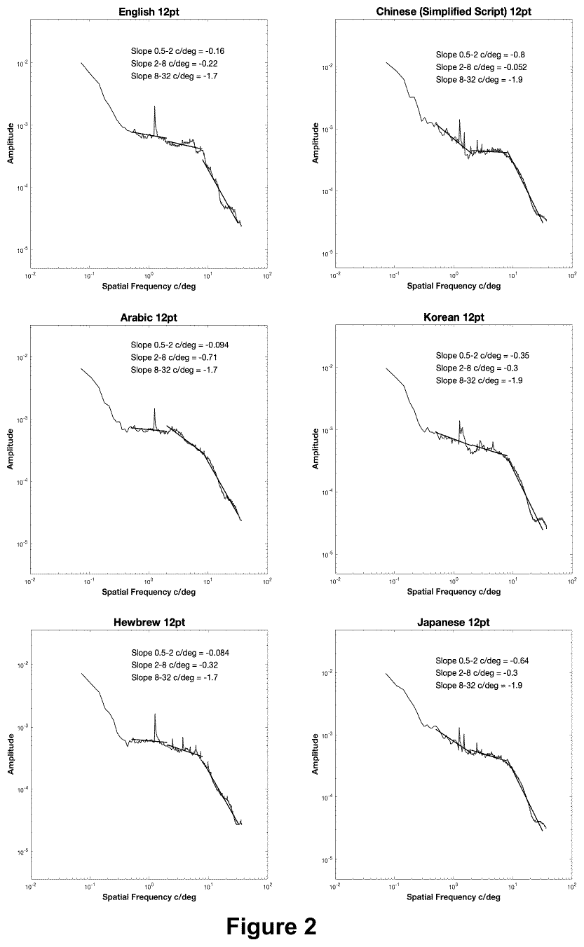

The analyses revealed that alphabets and scripts have a spatial frequency spectrum that deviated markedly from natural images, as illustrated in FIG. 2. Rather than a typical linear spectrum on log/log plot, text images were highly non-linear. Line and character spacing contributed one or two narrow frequency peaks depending on the alphabet/script. All languages showed similar spatial properties and deviated from natural images in having higher contrast and flatter amplitude/frequency spectra below 8 c/deg (0.5-2 c/deg: mean −0.39, sd 0.30; 2-4 c/deg: mean −0.27, sd 0.19) but the high frequency segment was much steeper, comparable to those previously reported for indoor environments (mean −1.76, sd 0.16). For all languages there is a significant difference between low/intermediate and high SF slopes (P<0.0001) and the slope of each segment was outside the 95% confidence intervals for natural image spectra (−0.91 to −0.89). All Asian languages showed a significantly steeper high SF slope than European/Middle Eastern languages (P<0.0005). No significant differences were observed between a serif (Times Roman) and sans-serif font (Arial) in English text.

TABLE 1
Slope of the log amplitude vs log SF
relationship for different languages

| | Low SF | Intermediate SF | High SF |
|---|---|---|---|
| | 0.5-2 c/ [symbol] | 2-8 c/ [symbol] | 8-32 c/ [symbol] |
| English (Roman) | −0.16 | −0.25 | −1.55 |
| Russian (Cyrillic) | −0.26 | −0.2 | −1.56 |
| Greek | −0.31 | −0.21 | −1.64 |
| Hebrew | −0.08 | −0.32 | −1.67 |
| Arabic | −0.09 | −0.71 | −1.68 |
| Korean | −0.35 | −0.30 | −1.94 |
| Japanese | −0.64 | −0.30 | −1.93 |
| Chinese (traditional) | −0.85 | −0.07 | −1.92 |
| Chinese (simplified) | −0.80 | −0.05 | −1.92 |
| mean | −0.39 | −0.27 | −1.76 |
| SD | 0.30 | 0.19 | 0.17 |
| [symbol] | 0.10 | 0.06 | 0.06 |

According to one embodiment of the present invention a method and system is provided to alter the spatial frequency information in text to create a spatial frequency profile that closely resembles a natural outdoor environment. At the same time the spatial detail required to retain the informational content of the text is preserved. The invention thereby has the consequence of changing written text from a stimulus that promotes the development of myopia, to one that helps to prevent myopia.

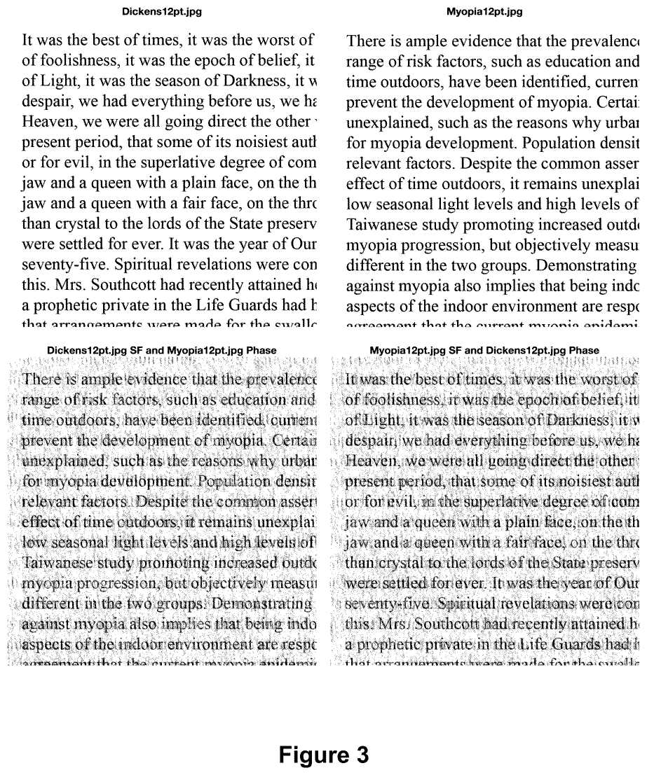

The invention can be achieved in a number of ways to determine one or more filtering parameters dependent on an analysis of the data text. Fourier analysis shows that spatial information can be divided in the amplitudes of different frequencies and their respective phases. FIG. 3 illustrates an example how most of the information content in text is contained in the phase spectrum. In this example two samples of English text are used, one from a book Charles Dickens and one from a paper on the myopia development. If the spatial and frequency spectra of these two passages of text are swapped and recombined into two new images, it can be seen that the language and content follows the phase information not the spatial information.

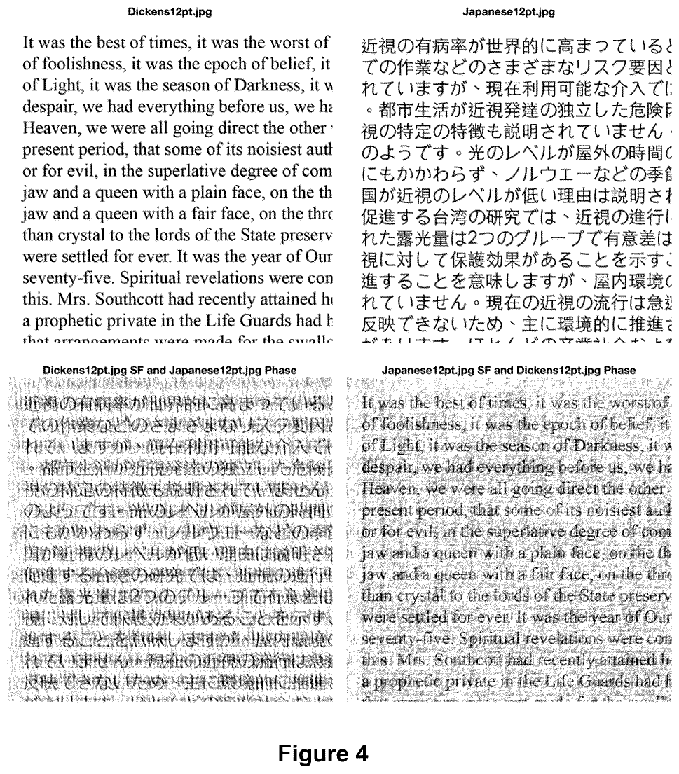

This implementation can also be shown when using entirely different scripts or alphabets, as shown in FIG. 4. In this example the Fourier transform of the English text in the top panel has been mixed with the Fourier transform of a Japanese translation of these words. The lower panels show the result when the spatial frequency spectrum of the Japanese text is recombined with phase spectrum of the English text. Although indistinct, the English words are clearly visible. This shows that preserving the phase spectrum will retain the meaning of the words, even if the spatial spectrum is altered. In these examples the legibility of the text is significantly impaired.

Effectively the invention alters the spatial spectrum of text in a manner that preserves readability, while delivering a useful transformation of the spatial spectrum to resemble the natural outdoor world which represents the least myopigenic environment setting.

To determine the spatial spectrum differences between languages and the natural the amplitude ratio between analysed pieces of text and an ideal amplitude=1/f spectrum is calculated.

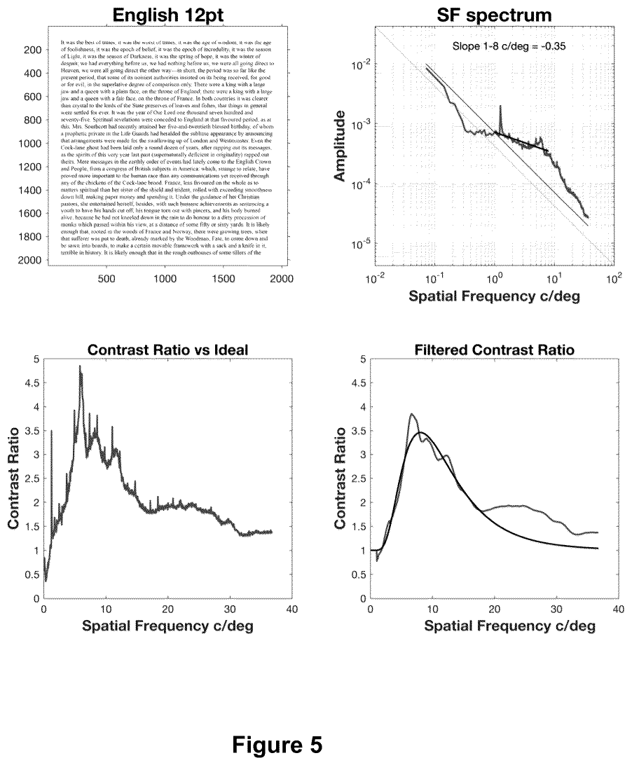

As shown in FIG. 5, the contrast ratio between text and an ideal natural spectrum shows a peak at around 8 cycles per degree. To adjust the spatial frequency spectrum of text towards the ideal spectrum requires the application of a relatively narrow band spatial filter. The spectral properties of the ideal filter can be calculated from the contrast ratio of text to the ideal spectrum as shown in the lower right panel. Some of the fine detail spatial peaks on the spectrum relate to important spatial details of text such as the spacing between lines, spacing between characters (kerning) and the features of the line elements that make up the characters. In order to alter overall spatial frequency spectrum while maintaining readability this invention preserves the fine details of the spectrum, but adjusts only the overall profile.

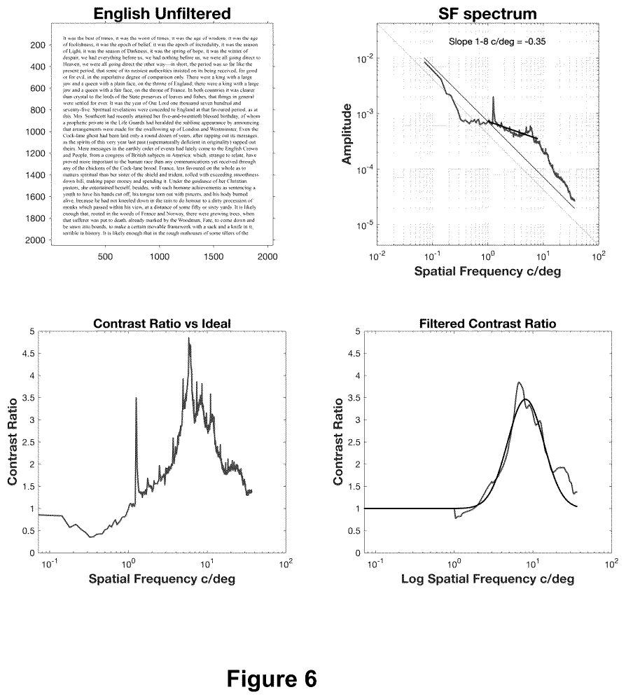

To alter the overall spectrum without removing such detail a number of approaches according to the invention can be implemented. Firstly, to low-pass filter the contrast ratio data and secondly to create a mathematical model which fits the shape of contrast ratio curve over the most important range of spatial frequencies for vision. This asymmetric filter profile is far more symmetric when plotted on a log scale for spatial frequency, as shown in FIG. 6.

One formula that achieves this symmetrical function on a logarithmic scale of frequency (f) with the parameters of amplitude (A), peak frequency (peakf) and a bandwidth parameter (sigma) is as follows:

$$Contrast Ratio = 1 + A \cdot exp ( - {( log 10 ( f ) - log 10 ( peakf ) )}^{2} / ( 2 * log 10 {( sigma )}^{2} ) )$$

The required attenuation function is therefore

$$Attenuation = 1 / [ 1 + A \cdot exp ( - {( log 10 ( f ) - log 10 ( peakf ) )}^{2} / ( 2 * log 10 {( sigma )}^{2} ) ) ]$$

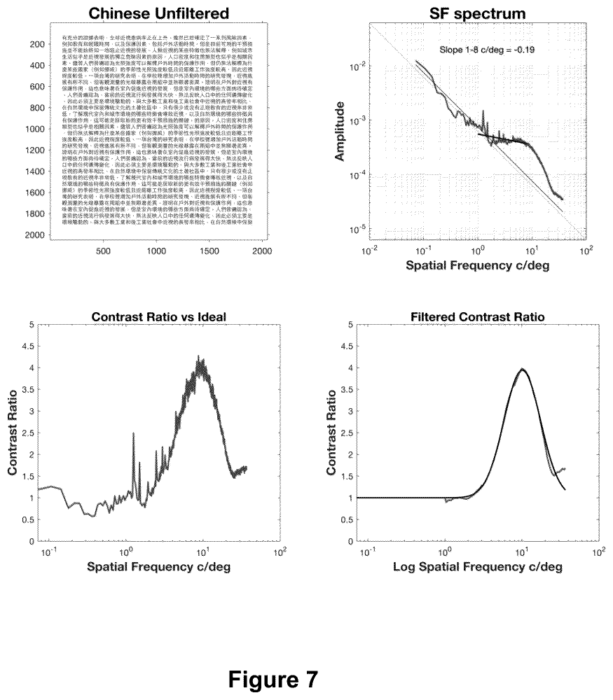

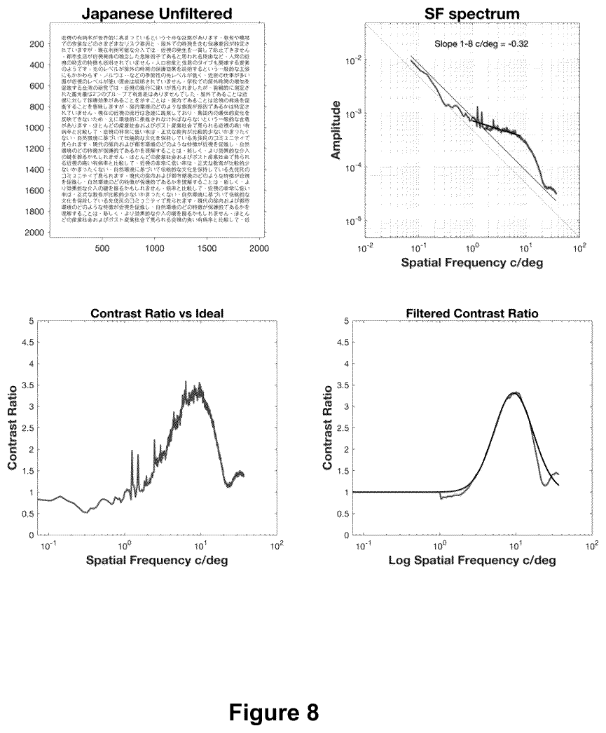

The parameters of the model are estimated by fitting this equation to the filtered spectrum using non-linear optimisation. In the above example A=2.46, peakf=8.08 c/deg and sigma=1.70 c/deg. FIGS. 6, 7 and 8 this function provides an excellent fit for the contrast ratio vs an ideal spectrum for different languages, which shows the operation of the invention for English, Chinese and Japanese text.

The parameters of the ideal model vary between languages to a small extent, as shown in Table 2, but overall there is a consistent pattern of filter parameters across a very diverse set of scripts.

TABLE 2

| Language | A | peaksf | sigma |
|---|---|---|---|
| English 12 pt | 2.46 | 8.08 | 1.70 |
| Chinese 12 pt | 2.94 | 10.10 | 1.70 |
| Japanese 12 pt | 2.31 | 9.20 | 1.81 |
| Arabic 12 pt | 2.27 | 7.75 | 2.03 |
| Hebrew 12 pt | 2.74 | 7.59 | 1.74 |
| Russian 12 pt | 2.70 | 8.30 | 1.70 |
| Korean 12 pt | 2.73 | 8.34 | 1.80 |

These parameters relate to the log-Gaussian model described above. Other functions that are symmetrical, or near-symmetrical, functions of log 10(f) could also be used such sinusoidal functions, normal-exponential-gamma distribution or exponentially modified Gaussian distribution.

Other aspects of text layout affect the required adjustment to achieve an ideal spatial frequency spectrum. These include font, font size and line spacing. The results are shown for English text.

TABLE 3
Fonts Analysed

| Text Parameter | A | peaksf | sigma |
|---|---|---|---|
| Times 10 pt | 3.06 | 9.31 | 1.80 |
| Times 12 pt | 2.46 | 8.08 | 1.70 |
| Times 14 pt | 2.58 | 7.17 | 1.69 |
| Times 12 pt | 2.86 | 8.06 | 1.76 |
| double spaced | | | |
| Times italic 12 pt | 2.35 | 8.53 | 1.70 |
| Arial 12 pt | 2.42 | 7.24 | 1.58 |
| Chancery 12 pt | 2.82 | 8.46 | 1.90 |
| Noteworthy 12 pt | 2.50 | 9.22 | 1.68 |
| Chalkduster 12 pt | 1.08 | 5.82 | 1.45 |

Fonts analysed in Table 3 shows line spacing has relatively little impact. Smaller font sizes lead to a shift to higher spatial frequency in the filter centre frequency. Different font designs (serif vs non-serif, and normal vs italic) generally showed little variation, but a font designed to look like chalk writing with softer edges showed the lowest difference in spatial frequency to an ideal spectrum. This table shows that the invention can also be used to compare fonts in terms of their frequency spectrum and select the most suitable font for use in situations where myopia development is at high risk (notably books and written matter designed for use in schools).

For a given language and font size, the actual words and meaning of the text has very little impact on fitted model parameters. Table 4 shows the model parameters for two completely different blocks of text, one from Dickens and one from a myopia-related research paper.

TABLE 4

| Text Parameter | A | peaksf | sigma |
|---|---|---|---|
| Myopia paper | 2.43 | 8.20 | 1.64 |
| Dickens | 2.46 | 8.08 | 1.70 |

Narrow band filtering can be achieved using the Fourier transform or by image convolution with a spatial kernel, depending on the application required. Spatial filtering kernels such as a gabor patch or DOG (difference of gaussian) can be designed to have band-pass filtering features that can be matched to the desired filtering parameters. A relatively narrow band spatial frequency attenuation filter can be achieved by apply such a band-pass kernel by convolution with the source image and then subtracting an appropriately scaled output from this convolution from the original image.

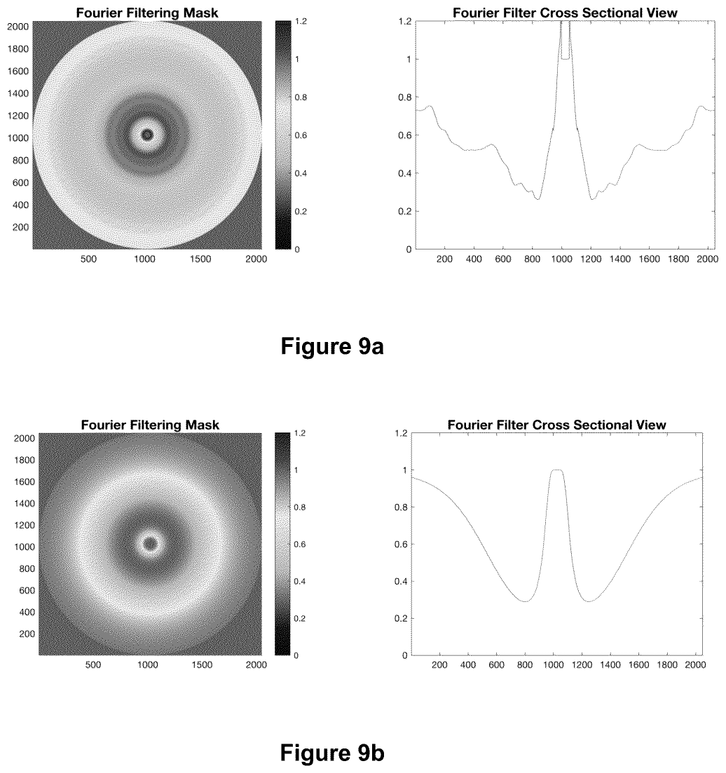

Optical blurring or blurring with diffraction filters or diffusers cannot achieve this pattern of spatial frequency modification as such physical filters show higher levels of attention at high spatial frequencies, rather than showing tuning to a specific band of spatial frequencies. To filter the text image in the spatial domain using a Fourier transform, a filter mask is created which is then multiplied with the two-dimensional FFT amplitude spectrum. To achieve this, the zero frequency point is shifted to the centre of the FFT matrix. The profiles of the required filter masks are created from either the filtered contrast ratio curve or the above model. FIG. 9a illustrates a filter mask used to filter image in the spatial domain.

Applying these filters to the FFT of the spatial frequency spectrum of the text and recombining with original phase spectrum of the text allows reconstructed, spatially filtered text to be recreated that shares the frequency spectrum characteristics of natural outdoor environments. FIG. 9b illustrates the FFT of the spatial frequency spectrum of the text and recombining with original phase spectrum of the text.

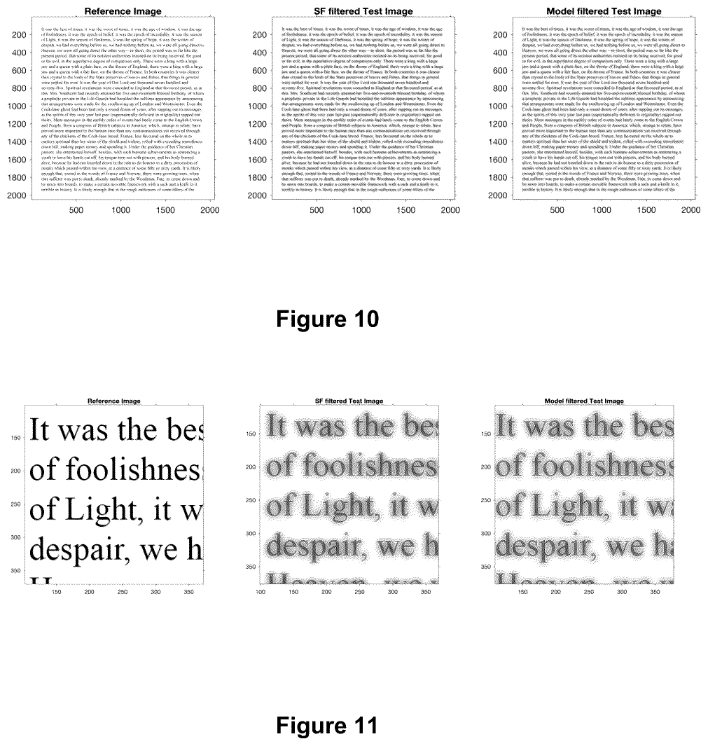

FIG. 10 shows a number of examples of reconstructed, spatially spectrum modified text and FIG. 11 is an enlarged view of some of text in FIG. 10 shows comparison of results with filtered FFT spectrum and the log-gaussian model in clearer detail.

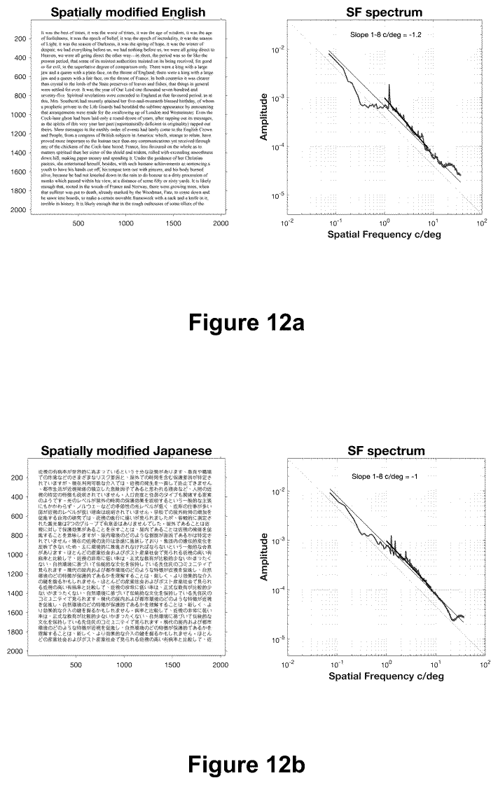

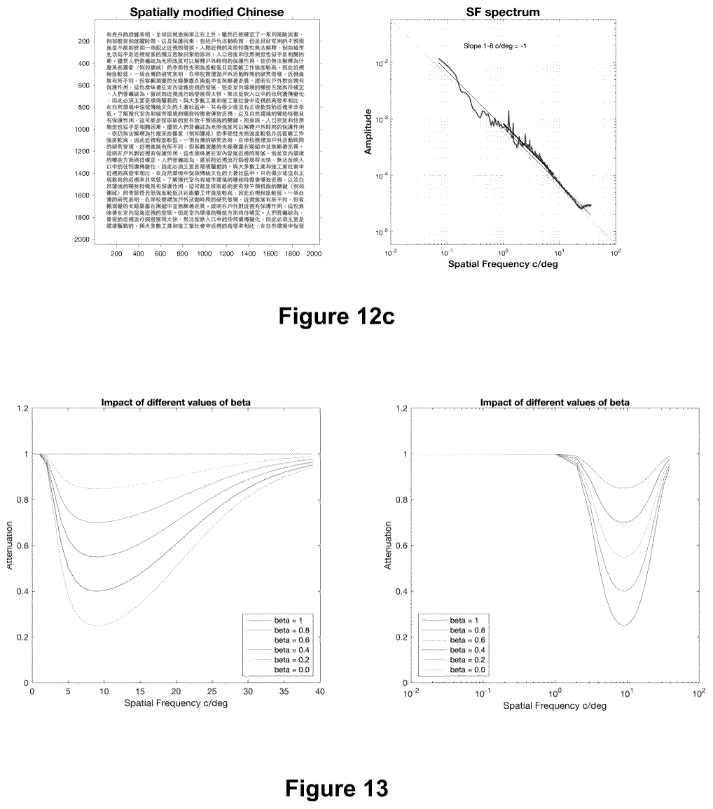

FIGS. 12a, 12b and 12c illustrate the spatial spectra of such filtered texts in three languages, namely English, Japanese and Chinese.

This approach shows that legible text with spatial spectrum resembling the natural outdoor world is generated, according to the invention. It will be appreciated that there is a balance between achieving a perfect result and readability for the end user.

In one embodiment the invention is configured to adjust the confidence levels so that the amount of adjustment of the spatial transformation is controlled. When it comes to the spatial spectrum, one can use the 95% confidence intervals of a collection of natural images to determine what is adequate. By doing this one can reduce the amount spatial manipulation to achieve the desired result with improved legibility of the text. A scaling parameter (beta) can be incorporated into the Attenuation calculation. A beta value of 0, represents no spatial modification and a beta value of 1.0 represents complete spatial optimisation (as shown above).

This can be achieved using the equation:

$$Attenuation = 1 + beta \cdot ( 1 / ( 1 + A \cdot exp ( - ( {( log 10 ( f ) - log 10 ( peakf ) )}^{2} / ( 2 * log 10 {( sigma )}^{2} ) ) ) ) - 1 )$$

FIG. 13 illustrates the impact of a scaling factor on the spatial frequency attenuation and shown in a linear and log-linear plot.

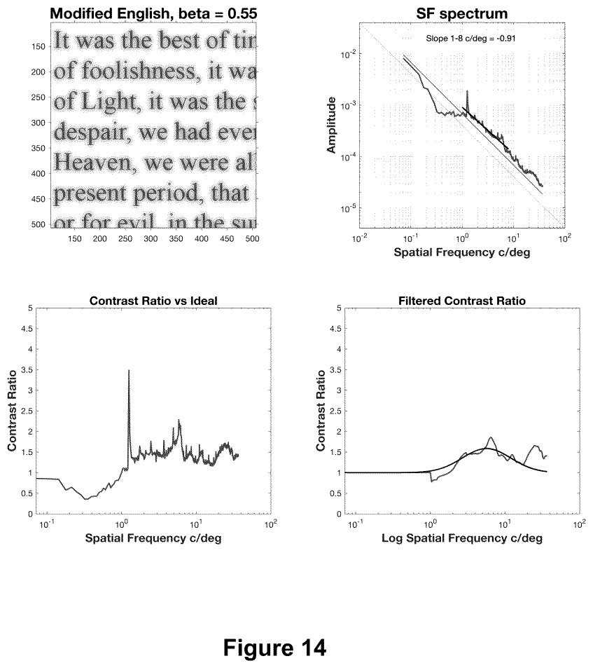

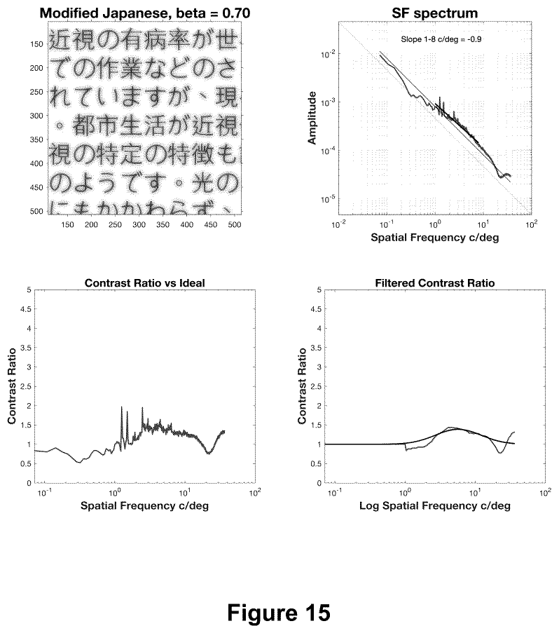

FIG. 14 illustrate an English text beta value of 0.55 and change the slope of the frequency spectrum to within the 95% confidence intervals of the natural images. For a Japanese a beta value of 0.70 was required, as shown in FIG. 15. The text has been zoomed in to allow easier judgement of readability.

This shows that graded application of this invention to text can achieve the desired goals of changing the spatial frequency spectrum of text to be within the statistical ranges of natural environments while maintaining a high level of legibility. The filtering required can be based on a smoothed spectrum of the actual source text, a model based on the smooth spectrum or a precalculated set of parameters (as shown in Table 2).

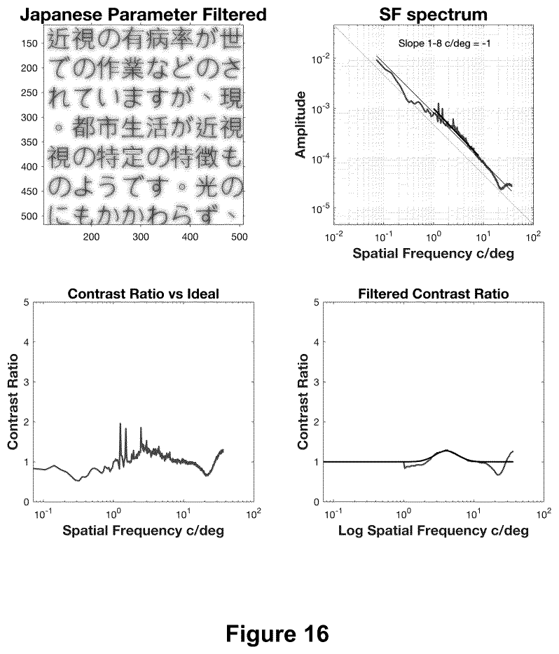

To demonstrate the flexibility of the model approach, FIG. 16 uses the parameters derived from English text, and applies them to the above Japanese text with a beta value=0.7 (as above). The resulting text, is easily readable and has a close to ideal spatial spectrum with slope of −1.

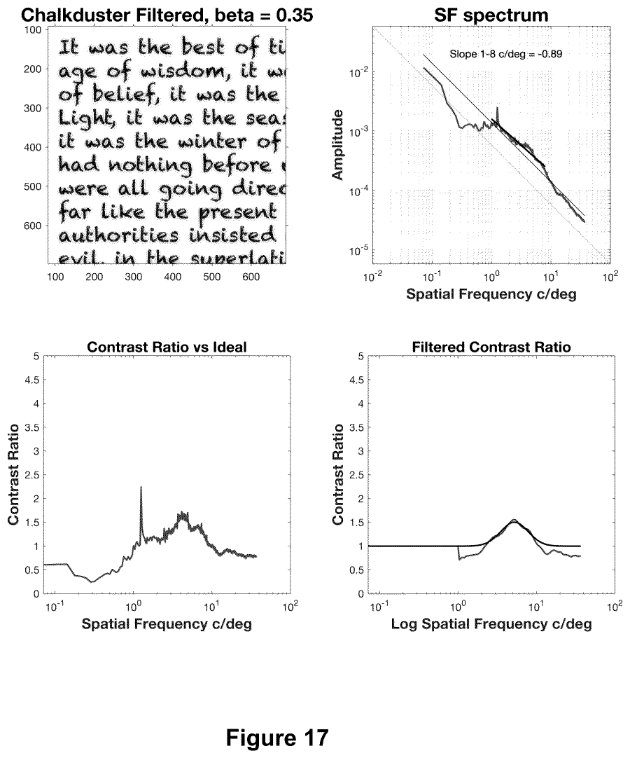

Fonts that have lower filtering requirements because of their baseline characteristics show higher levels of legibility when the spatial frequency spectrum is adjusted as shown in FIG. 17. For this particular font a beta value of only 0.35 (i.e. only providing 35% of the ideal filter attenuation) creates a spatial frequency spectrum within the range of slopes of natural images.

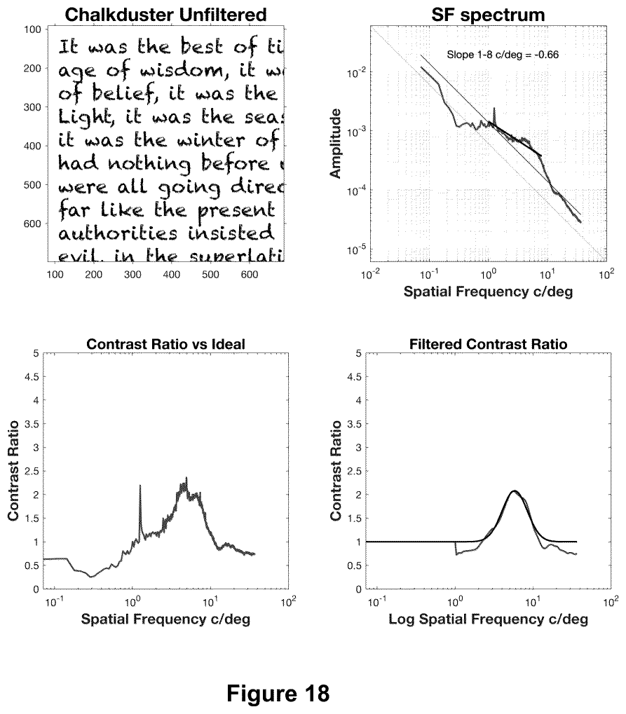

The introduction of this scaling factor also provides a method for a user to adjust the level frequency optimisation in real time, effectively providing an anti-myopia dial allowing the user to turn up or turn down. For example, one application of this is where a parent is sharing an ebook with a myopic child and wishes a stronger anti-myopia stimulus. Another application whereby within the effective range, a user may chose a scaling level that reaches an acceptable level of legibility of the text. FIG. 18 illustrates the text when the filter beta value is zero.

The scaling factor allows a method of reducing the visual impact on the text at the expense of potentially achieving a sub-optimal spatial frequency spectrum. As well as reducing the contrast in the spatial range over-represented in text, an optimal spatial frequency profile can be achieved by adding a background texture or ‘noise’ to the background on which the text is displayed. The same parameter model described above can be applied to this process. In this embodiment, the texture or noise is selected or created to have the desired amplitude spectrum of 1/f^{a} or a power spectrum of 1/f^{2a}. In order to create a complementary power spectrum to the filtered text, the parameters of a chosen filter model can be used to filter out the frequencies over-represented in the text. The resulting frequency spectrum will therefore have reduced amplitude at the spatial frequencies over-represented in the text image. Adding graded amounts of this filtered noise to the background on which the text is displayed will increase the contrast at low and high spatial frequencies that are under-represented in text. The combined power spectrum will therefore resemble a natural image in having a more linear spectrum with slope of −α.

If a font is selected that inherently has a better than usual spatial frequency profile, then it may be sufficient just to add the background texture or noise in order to achieve a spectrum within the statistical limits of natural scenes.

### Additional Embodiments

The required spatial filter is a symmetrical function on a log axis and well fitted by the log-gaussian model above. This property is also shown by the logGabor function, which can be used to create a set of orientation and band-pass frequency filters to achieve a similar result if orientational aspects of the spectrum were required. The mechanisms whereby eye growth is regulated by the retinal image are not fully elucidated, but it is established that this is achieved within the eye. The visually responsive cells in the eye are typically not orientation selective, hence they are performing a similar form spatial analysis to the technique applied in this invention whereby the spatial spectrum is rotationally averaged to combine the spatial characteristics of all orientations. There are however some cells that show elongated receptive fields that may have some orientation selectivity. It is therefore a useful extension of this invention to allow for orientation dependent filtering parameters.

The invention can be applied to computer screens, ebooks, phones and tablets where the text is modified by a software implementation of the above approach. The invention could also be implemented within printers to allow printed texts with modified spatial frequency spectra for school books and young readers to reduce myopia progression. The invention could also be applied to existing computer fonts so that any text could be displayed or printed with the benefit of an optimised spatial frequency profile. The invention can also be applied frame by frame to videos that contain textual or other content with spatial contrast that can be processed in the described manner.

Spatial frequency is a function of visual angle and therefore the spatial frequency features of a page are altered depending on the viewing distance. For a printed book there is a great deal of data about habitual viewing distance that can be used to estimate the viewing distance and hence scale the spatial frequencies accordingly. For computers, e-books, mobile phones and tablets, where the filtering process can be conducted in real time by modern, powerful graphic processing chips, viewing distance may be monitored by the device using proximity sensors (e.g. ultrasound or ‘time of flight’ optical sensors) or video analysis (e.g. of interocular separation). This distance data can be used to adjust the filtering parameters in accordance to effective font size. As shown above, font size changes lead to changes in the filter parameters. Viewing a 10 point font at a closer than usual viewing distance increases the angle subtended by each letter and effectively means that eye is exposed to an apparently larger font size. Depending on the actual viewing distance as measured by the device, the filter parameters can be adjusted to match the effective font size rather than the absolute displayed font size.

Text can be filtered in the manner described in this invention using the smoothed FFT data of input data to create the appropriate filter, but the modelled filter performs almost as well as the smoothed FFT filter. The optimal filter parameters for a wide range of common printing and computer fonts can be pre-processed and stored for later use. This method also allows for machine learning approaches to be applied, whereby data is analysed on a very wide range of fonts allowing for the best parameters to be estimated in the case of an unknown font being encountered. This approach can also be used to create an optimised set of parameters that will be used as a default across a range of fonts.

Fonts can also be pre-prepared to devices with limited computer processing capabilities such as low power ebooks. These may be pre-filtered versions of familiar fonts, with optimised filter parameters for each font size and style (i.e. italic or bold). Machine learning/artificial intelligence techniques can be applied to the process of creating fonts with inherently better spatial spectra. The chalkduster font described here has the characteristics of less distinct margins to the characters. As implied by the name this was presumably done to mimic the appearance of chalk on a board. With machine learning it is possible to analyse thousands of fonts to determine those with the best spatial characteristics and then randomly combine the design features of the best fonts to create spatially optimised fonts which can be pre-installed on devices such as ebooks, phones and tablets.

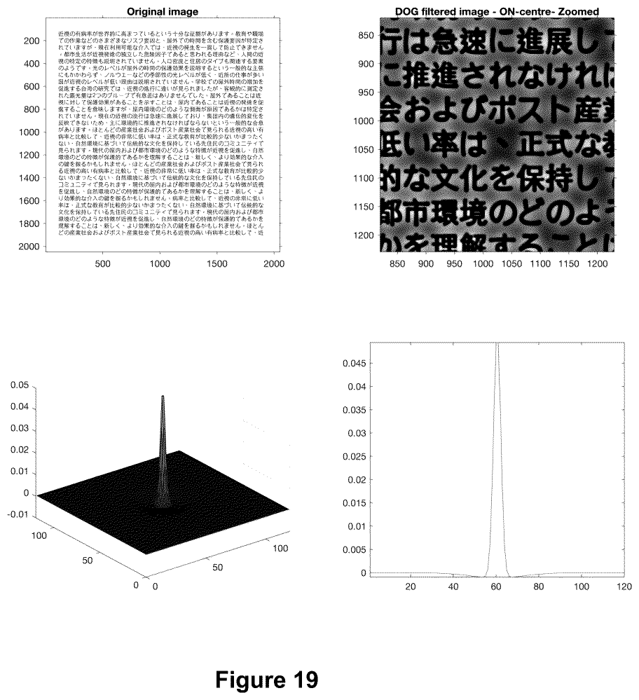

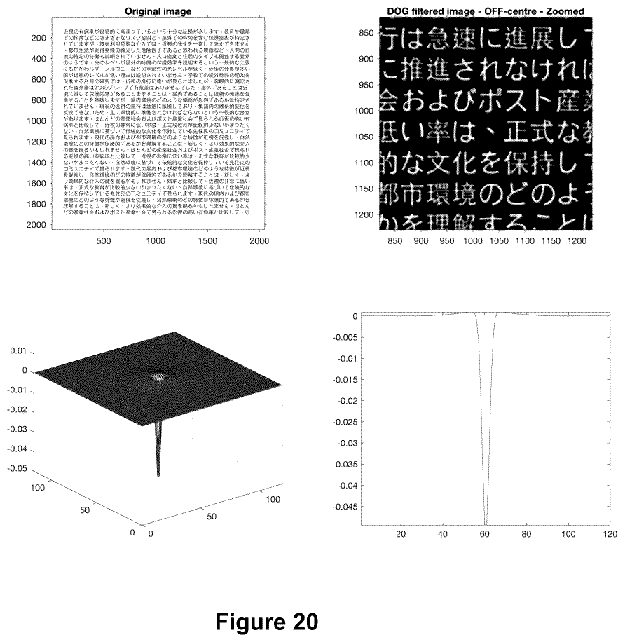

In another aspect of the invention, natural images have also been shown to have characteristic features in relation to the processing of certain types of retinal cells, notably the ‘ON’ and ‘OFF’ pathways, notably that natural images tend to have more dark-on-light contrast than light-on-dark contrast (Ratliff C P, Borghuis B G, Kao Y H, et al. Retina is structured to process an excess of darkness in natural scenes. Proc Natl Acad Sci USA 2010; 107: 17368-17373.) The same is true of printed text. This can be demonstrated by modelling the receptive fields of ON and OFF-centre retinal cells with a difference of gaussian function. This is shown in FIG. 19 (for ON-centre retinal cells) and FIG. 20 (for OFF-centre retinal cells), where a higher level of contrast is apparent in OFF centre receptive fields (as modelled by a difference of gaussian model).

FIG. 19 illustrates ON-centre simulation showing the stimulus text and the activation levels (dark=low activation, light=high activation of an array of ON-centre receptive fields within the retina. The lower two panels show the receptive field profiles in 3 dimensions and in cross-section.

FIG. 20 illustrates OFF-centre simulation showing the stimulus text and the activation levels (dark=low activation, light=high activation of an array of OF-centre receptive fields within the retina. The lower two panels show the receptive field profiles in 3 dimensions and in cross-section.

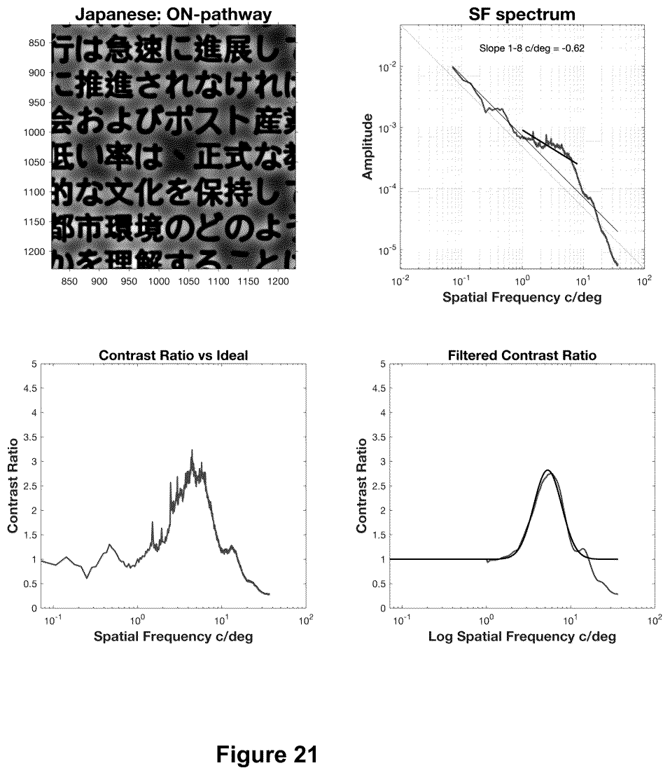

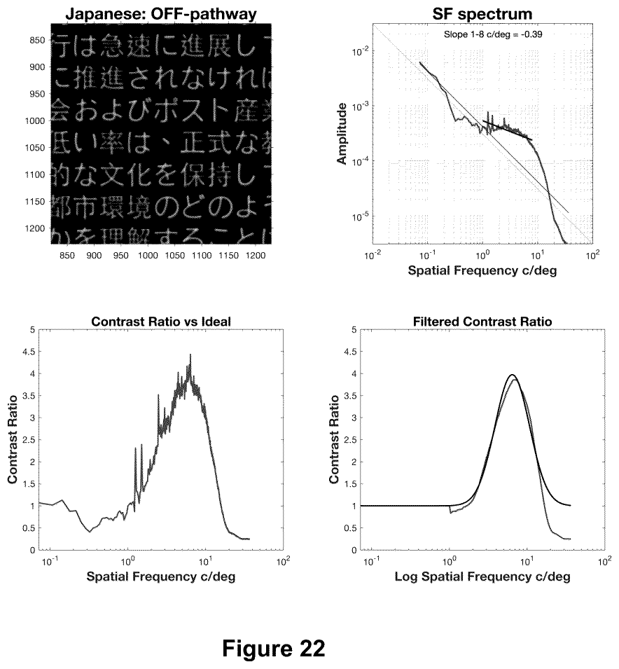

These separate pathways also show differences in the spatial spectrum as shown in FIG. 21 and FIG. 22. FIG. 21 illustrates a spatial spectrum of text as processed by ON-centre retinal cells compared to the ideal natural spectrum.

FIG. 22 illustrates a spatial spectrum of text as processed by OFF-centre retinal cells compared to the ideal natural spectrum.

The excess of intermediate spatial frequencies in written text is most apparent in the OFF-centre cell spectrum. The peak amplitudes of the contrast ratio between text and an ideal spectrum for this example are 1.82 for the ON-pathway and 2.95 for the OFF-pathway. In addition, the peak spatial frequencies (taking into account the finding that OFF-centre retinal cell receptive fields are 1.7 smaller than ON-centre retinal cells) are higher in OFF-centre cells (6.47 c/deg) than ON-centre cells (5.35 c/deg). Another application of this invention is therefore to adjust the spatial frequency spectrum of text so as to reduce the excess stimulation of the OFF pathway to match the normal pattern observed in the natural world.

Further, a person ordinarily skilled in the art will appreciate that the various illustrative logical/functional blocks, modules, techniques/algorithms and process steps described in connection with the embodiments disclosed herein may be implemented as electronic hardware, or a combination of hardware and software. To clearly illustrate this interchangeability of hardware and a combination of hardware and software, various illustrative components, blocks, modules, circuits, and steps have been described above generally in terms of their functionality. Whether such functionality is implemented as hardware or a combination of hardware and software depends upon the design choice of a person ordinarily skilled in the art. Such skilled artisans may implement the described functionality in varying ways for each particular application, but such obvious design choices should not be interpreted as causing a departure from the scope of the present invention.

For example, a system or device is configured to modify the appearance of a readable text, comprising a memory; a processor electrically coupled to the memory and configured to execute instructions received from the memory; and wherein the processor is further configured to implement the steps of FIG. 1a. It will be appreciated, as described above the modified data text is output to a display screen or a viewing device. In another embodiment the modified data text is output to a printer device for subsequent printing.

The process described in the present disclosure may be implemented using various means. For example, the process described in the present disclosure may be implemented in hardware, firmware, software, or any combination thereof. For a hardware implementation, the processing units, or processors(s) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa. The invention is not limited to the embodiments hereinbefore described but may be varied in both construction and detail.

### APPENDIX

1) Vitale S, Ellwein L, Cotch M F, Ferris F L 3rd., Sperduto R. Prevalence of refractive error in the United States, 1999-2004. Arch Ophthalmol 2008; 126:1111-9.
2) Zylbermann R, Landau D, Berson D. The influence of study habits on myopia in Jewish teenagers. J Pediatr Ophthalmol Strabismus 1993; 30:319-22.
3) Au Eong K G, Tay T H, Lim M K. Education and myopia in 110,236 young Singaporean males. Singapore Med J 1993; 34:489-92.
4) Thorn F, Cruz A A V, Machado A J, et al. Refractive status of indigenous people in the northwestern Amazon region of Brazil. Optom Vis Sci 2005; 82: 267-72.
5) Mountjoy E, Davies N M, Plotnikov D, et al. Education and myopia: assessing the direction of causality by mendelian randomisation. BMJ 2018; 361: k2022.
6) Bowrey H E, Metse A P, Leotta A J, et al. The relationship between image degradation and myopia in the mammalian eye. Clin Exp Optom 2015; 98: 555-563.
7) Smith E L, Hung L F. Form-deprivation myopia in monkeys is a graded phenomenon. Vision Res 2000; 40: 371-381.
8) Flitcroft D I, Harb E N, Wildsoet C F. The Spatial Frequency Content of Urban and Indoor Environments as a Potential Risk Factor for Myopia Development. Invest Ophthalmol Vis Sci 2020; 61: 42.
9) Rudnicka A R, Kapetanakis V V, Wathern A K, et al. Global variations and time trends in the prevalence of childhood myopia, a systematic review and quantitative meta-analysis: implications for aetiology and early prevention. Br J Ophthalmol 2016; 100: 882-890.
10) Field D J. Relations between the statistics of natural images and the response properties of cortical cells. J Opt Soc Am A 1987; 4: 2379-2394.

1. A computer implemented method to modify the appearance of a readable text, said method comprising the steps of:
obtaining a data text to be adjusted wherein the data text is representative of a readable text;
selecting a filtering model and one or more filtering parameters dependent on an analysis of said data text;
applying a spatial transformation to the data text according to the selected filtering model and filtering parameters to generate a modified data text having a different spatial contrast characteristic; and
outputting the modified data text as a readable text.

2. The computer implemented method of claim 1 wherein the modified data text is generated by altering spatial frequency information in the text to create a spatial frequency profile characteristic that closely resembles a natural outdoor environment.

3. The computer implemented method of claim 1, comprising the step of adjusting the spatial frequency spectrum of the data text towards a desired spectrum using a spatial filter.

4. The computer implemented method of claim 3 wherein the spatial filter is a bandpass or a narrow band filter.

5. The computer implemented method of claim 3 wherein, spectral properties of the spatial filter can be calculated from the contrast ratio of text to an ideal spectrum.

6. The computer implemented method of claim 1, comprising the steps of: using a low-pass filter with a contrast ratio data and creating a model which fits the shape of a contrast ratio curve over a selected range of spatial frequencies for visual reading.

7. The computer implemented method of claim 1, comprising the step of analysing the readable text for a particular font and comparing fonts in terms of their frequency spectrum and applying the spatial transformation based on the particular font.

8. The computer implemented method of claim 1, comprising the steps of: filtering the text data in the spatial domain using a Fourier transform; and applying a filter mask is created which is then multiplied with a two-dimensional FFT amplitude spectrum.

9. The computer implemented method as claimed in claim 8 wherein a zero frequency point is shifted to the centre of a FFT matrix, and profiles of the required filter masks are created from either the filtered contrast ratio curve or a model.

10. The computer implemented method of claim 1, comprising the step of adjusting confidence levels of the modified data text so that the amount of adjustment of the spatial transformation is controlled.

11. The computer implemented method of claim 1, wherein an amount of text adjustment is adjustable with a scaling parameter.

12. The computer implemented method of claim 3, wherein the spatial filter is a symmetrical function on a log axis and fitted by a log-gaussian model.

13. The computer implemented method of claim 3, wherein the spatial filter is a logGabor function configured to create a set of orientation and band-pass frequency filters to allow for orientation specific spatial filtering.

14. The computer implemented method of claim 3, comprising the step or measuring a viewing distance by a device on which the text is presented and adjusting the parameters of the spatial filter based on the measured viewing distance.

15. The computer implemented method of claim 3, wherein the spatial filtering of the text is calculated to increase the simulation of ON-centre retinal cells and decrease the stimulation of OFF-centre retinal cells.

16. The computer implemented method of claim 1, wherein a spatial frequency profile of a specific text font is analysed, spatial filtering applied and a modified text font is stored for later use.

17. The computer implemented method of claim 1, wherein a spatial frequency profile of the text is modified by the addition of a background texture or pattern.

18. The computer implemented method of claim 1, wherein the modified data text is output to a display screen or a viewing device.

19. The computer implemented method of claim 1, wherein the modified data text is output to a printer device.

20. The computer implemented method of claim 1 wherein the modified data text is generated by altering spatial frequency information in the readable text to create a spatial frequency profile characteristic that reduces or eliminates ocular growth response that leads to myopia development.

21. A computer system or device, configured to modify the appearance of a readable text, comprising:
a memory;
a processor electrically coupled to the memory and configured to execute instructions received from the memory; and
wherein the processor is further configured to:
obtain a data text to be adjusted wherein the data text is representative of a readable text;
select a filtering model and one or more filtering parameters dependent on an analysis of said data text;
apply a spatial transformation to the data text according to the selected filtering model and filtering parameters to generate a modified data text having a different spatial contrast characteristic; and
output the modified data text as a readable text to a display screen or a printing device.
